(19) United States
(12) Patent Application Publication
(10) Pub. No.: US 2009/0287708 A1
(43) Pub. Date: Nov. 19, 2009

(54) Trans-community online memorial website for decedent memorials organized by community within a larger geographic service area

(76) Inventor: Bruce William Baldwin, Erie, PA (US)

Correspondence Address: Bruce W. Baldwin, 5210 Mill Street, Erie, PA, 16509, US

(21) Appl. No.: 12/156,591

(22) Filed: Jun. 2, 2008

Related U.S. Application Data
(60) Provisional application No. 60/934,267, filed on Jun. 12, 2007.

(51) Int. Cl. G06F 17/30

(52) U.S. Cl. 707/9; 707/E17.001

(57) ABSTRACT

A trans-community online memorial website available over the World Wide Web for memorializing decedents with online memorials organized, listed, and displayed according to said website user's hometown and or otherwise specified local community and or other community or communities within said website's intended larger geographic service area.

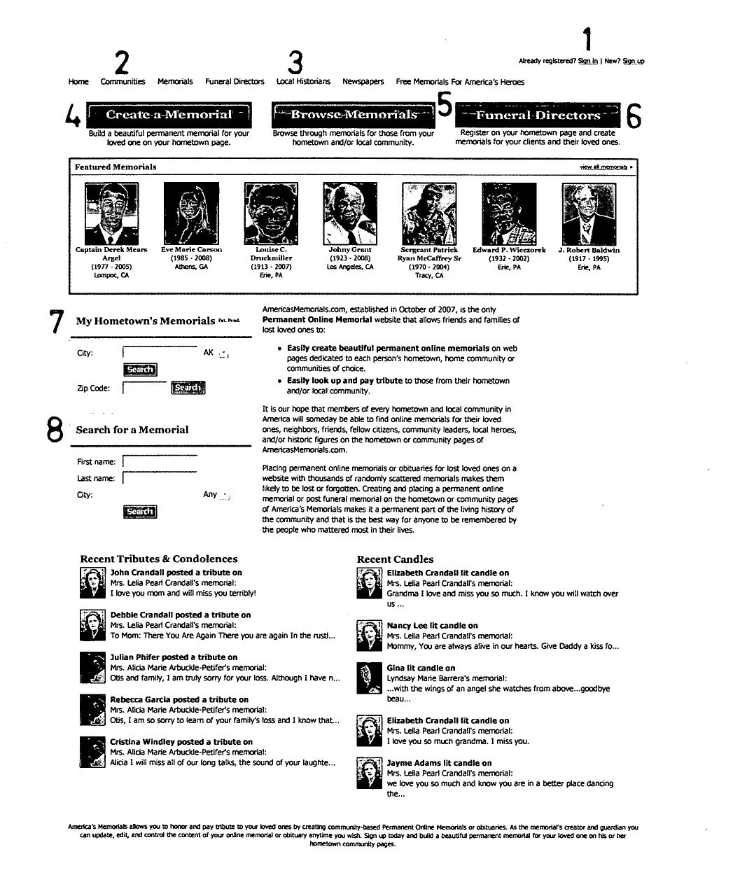

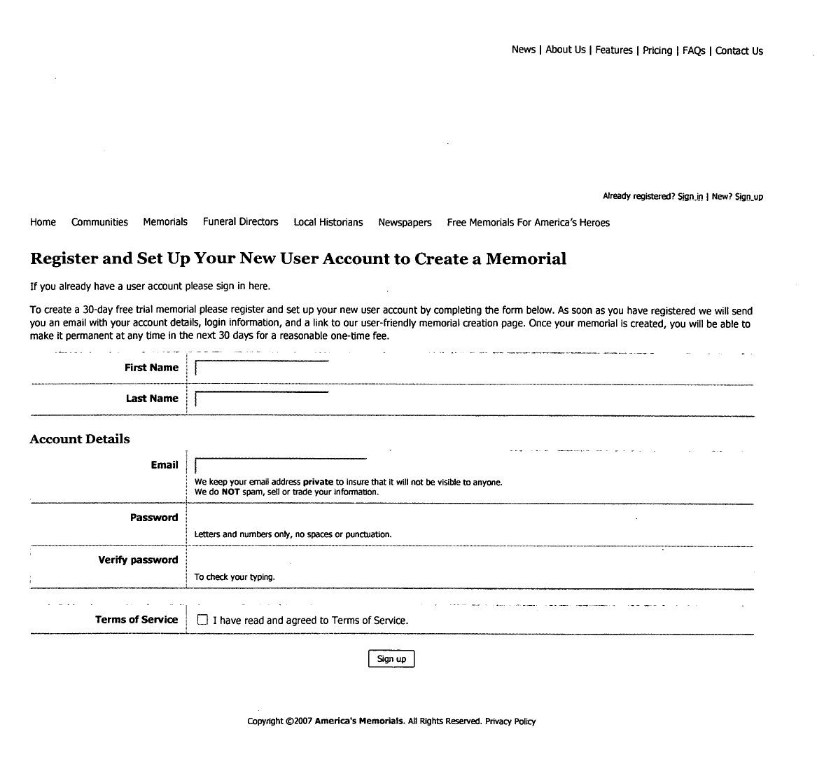

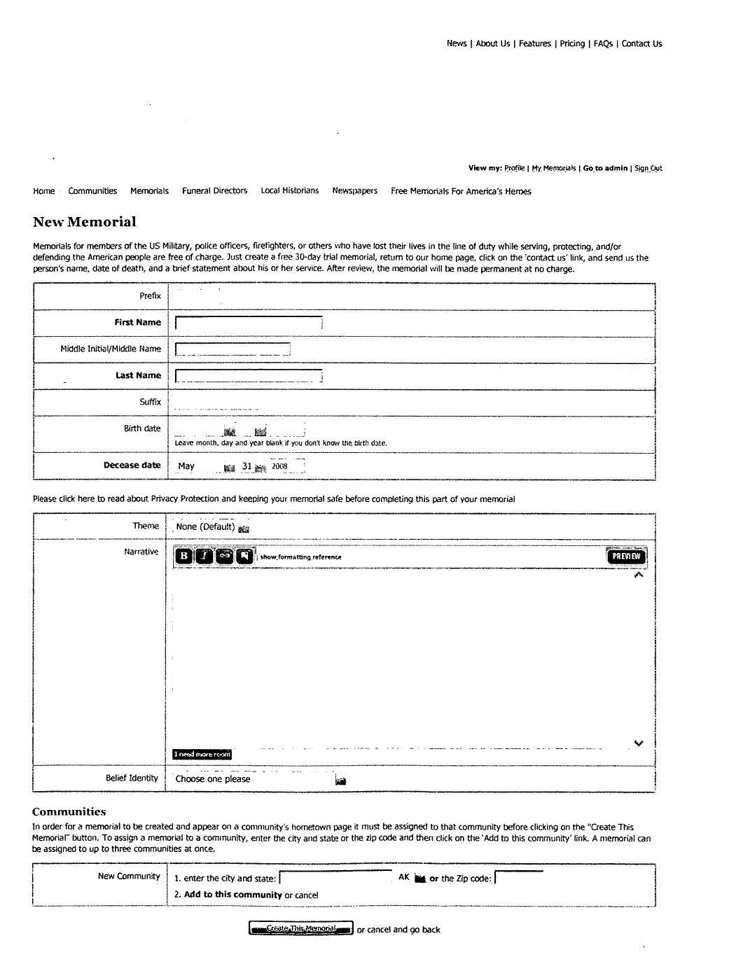

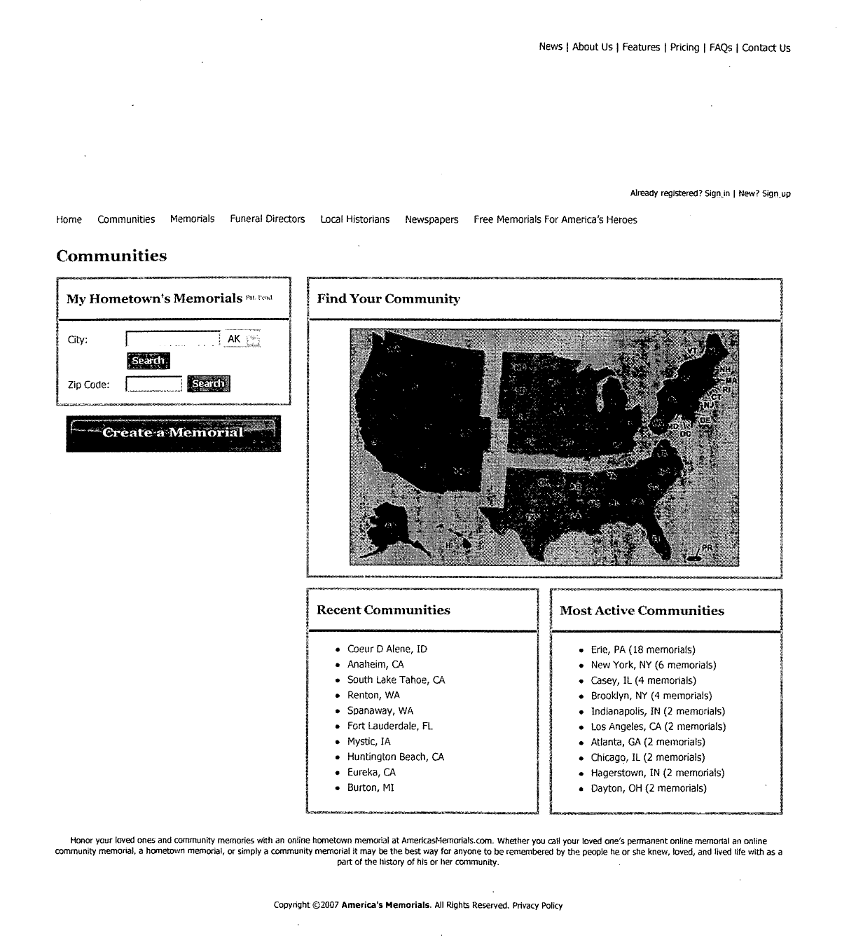

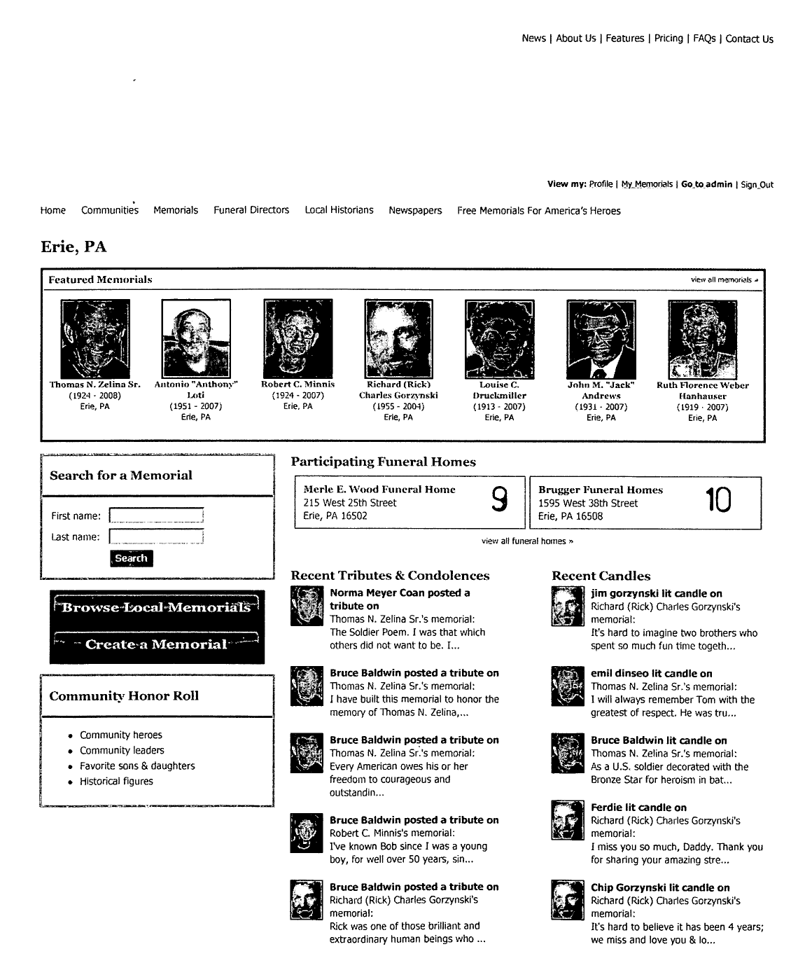

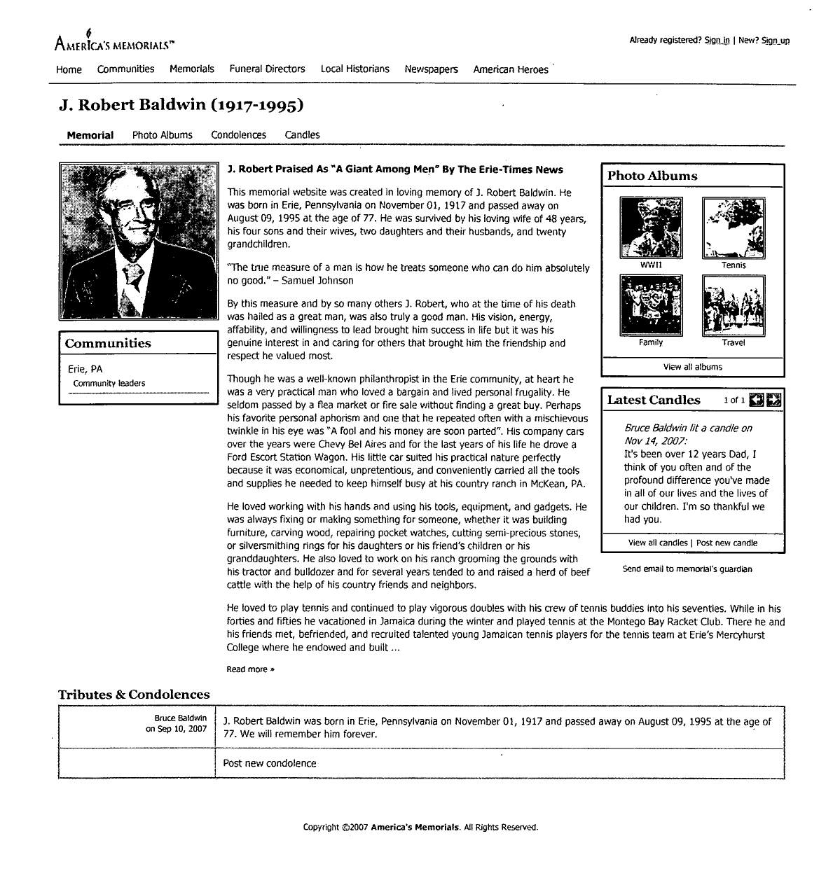

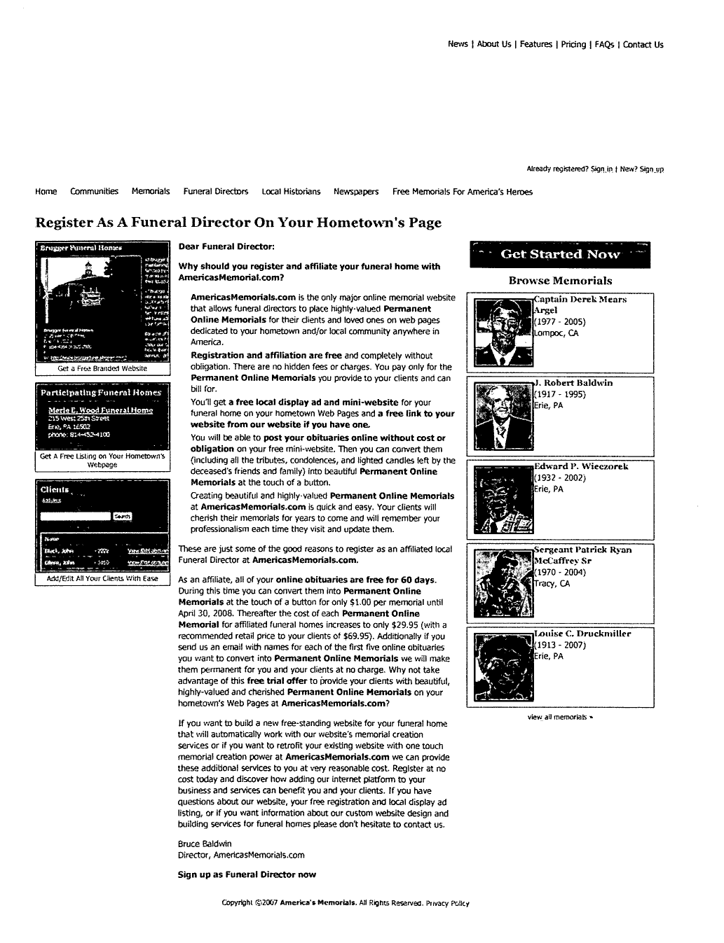

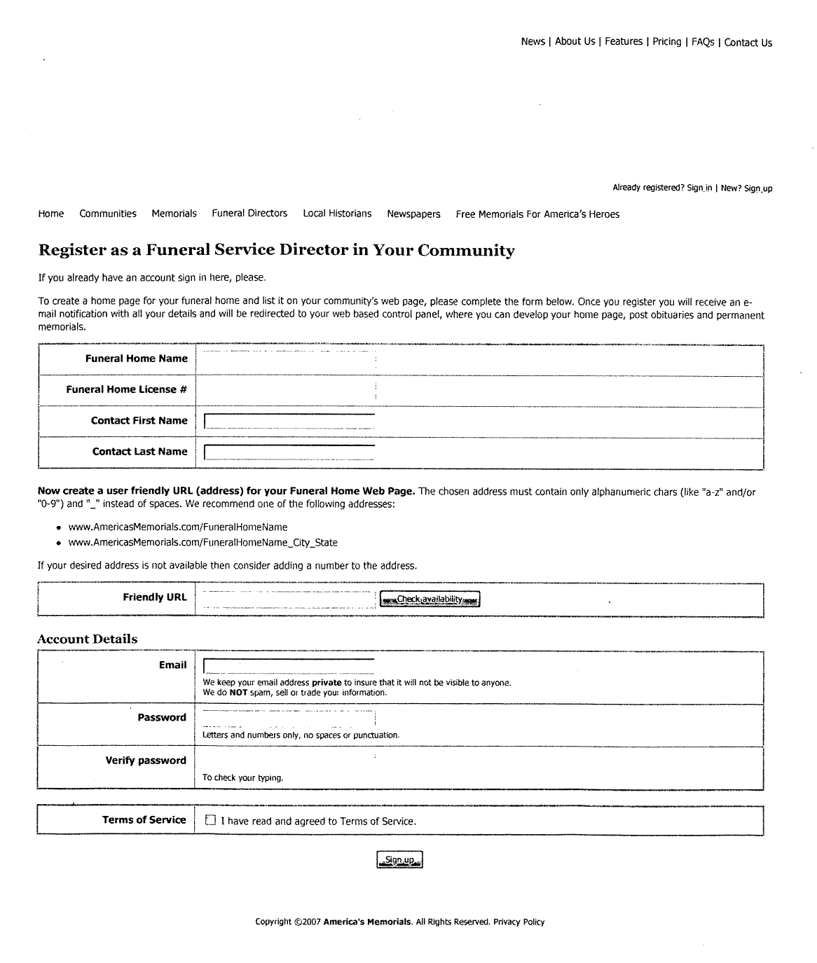

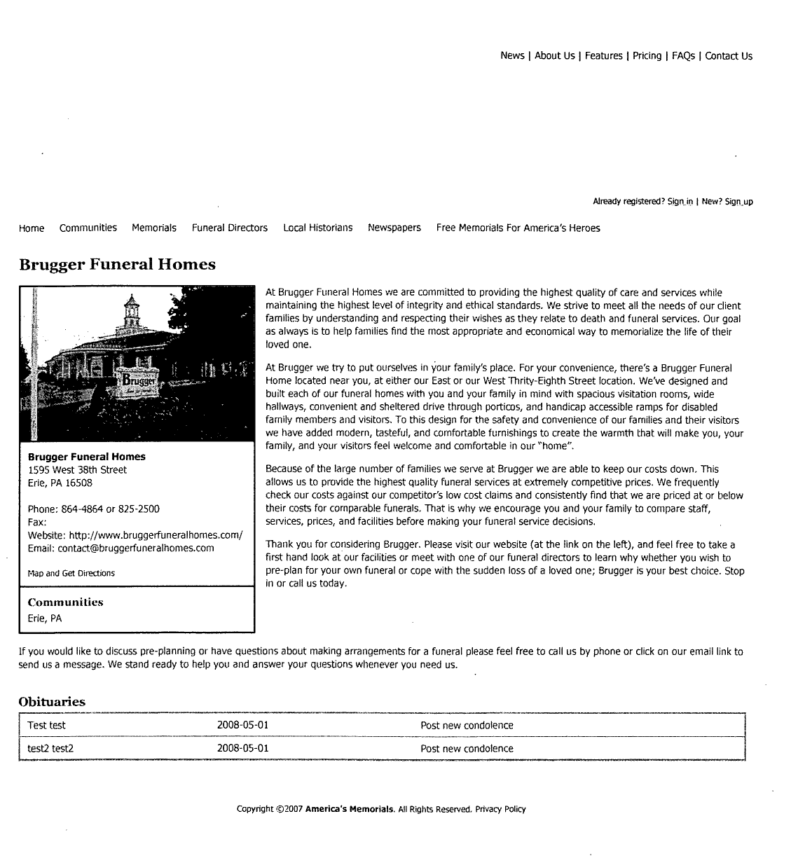

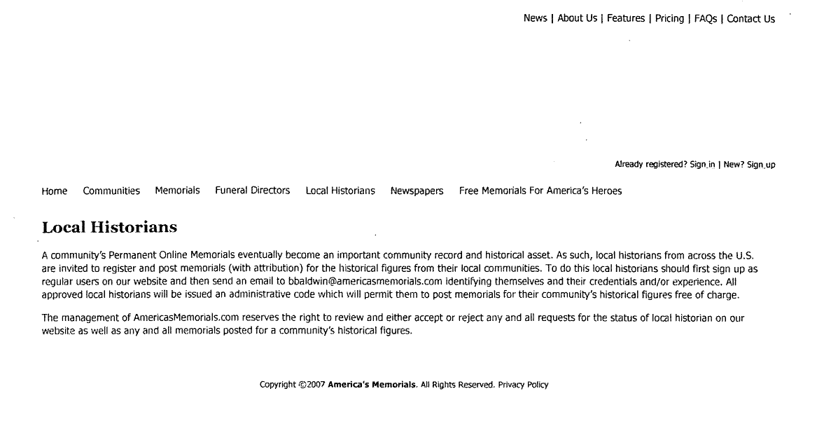

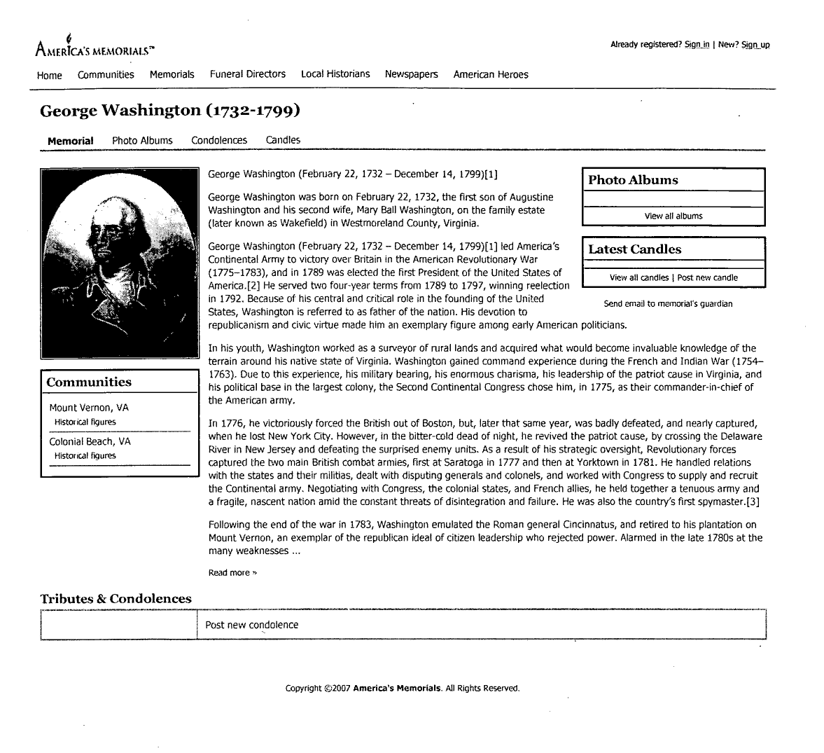

### CROSS-REFERENCE TO RELATED APPLICATIONS

This application claims the benefit of a provisional patent U.S. application Ser. No. 60/934,267, filed Jun. 12, 2007, by Bruce W. Baldwin, under the Title: Trans-Community Online Memorial Website For Memorializing Decedents With Online Memorials Organized, Listed, And Displayed According To The Website User's Hometown And Or Otherwise Specified Local Community Or Communities Within Said Website's Intended Larger Geographic Service Area.

### FEDERALLY SPONSORED RESEARCH

Not Applicable

### SEQUENCE LISTING OR PROGRAM

The sequence listing and source code for the Website invention herein referenced is included in this application as a computer program listing appendix on two identical CD-ROM discs labeled “Copy 1” and “Copy 2”. The files are all in ASCII format, readable in any text editor. The discs and files can be read using all machine formats including IBM PC and Apple Mac and are compatible with all operating systems including Microsoft Windows, Apple Mac, OSX, Linux and Unix. The file list below shows all the files on the discs, grouped by folder, with the date and time of creation, name and size in bytes. The word “<DIR>” indicates a directory.

### BACKGROUND OF INVENTION

1. Field of Invention

The invention directly and specifically relates to the creation, publication, organization, and display of Internet based memorials to honor and remember decedents on a trans-community online memorial website and to the business of the funeral services industry.

2. Prior Art

Roughly one-third of Americans now forego traditional burial and internment. In recent years there has been an increase in the numbers of citizens choosing non-traditional burial rites throughout much of the developed world. As a result of this phenomenon and the rapid growth of the World Wide Web as a repository for and source of information; citizens throughout the world are choosing to memorialize and honor their deceased family members, friends, and loved ones on internet websites dedicated to and designed for this purpose. Existing online memorial websites offer their users web based memorializing services without regard to organizing, publishing, listing, and displaying said memorials according to the decedent's or website user's hometown, local community, or communities of life. No such websites offering online memorial creation and hosting to users on larger trans-community scales yet offer website users the capability to create, publish, organize, list, and display decedent's memorials on web pages specifically and or exclusively dedicated to the user's choice of hometown, local community, and or otherwise specified communities so that said memorials, referenced to a given community, can then be published, listed, displayed and accessed by website users and visitors as a whole and important part of a community's historical heritage and the heritage of the citizens of that community.

### OBJECTS AND ADVANTAGES

Several objects and advantage of the herein described website invention are identifiable. Creating and placing a permanent online memorial for a lost loved one on the hometown or community pages of said website invention makes it a permanent part of the living history of that hometown or community and is therefore a better way for a person to be memorialized, for his or her memorial to be found by the persons who mattered most in his or her life, and for that memorial to be conserved as a part of the historical heritage of his or her community. Placing a permanent online memorial on all other and previously existing decedent memorializing websites provides no integrated community context for said memorial which makes it more likely to be lost, forgotten, and or less accessible to the members of his or her community and certainly does not insure that said memorial and the life and memories attached thereto will become a part of the integrated historical heritage of any community.

In addition, organizing, publishing, listing, and displaying a decedent memorial website's online memorials according to specified communities' sets of memorials along with the creation of a discreet homepage and or related web pages for each community on said website creates a unique and significant bilateral business relationship opportunity for said website and its operating company and its affiliated and registered funeral service directors. It allows local funeral service directors to reach website visitors and users through their local community's home page and or related web pages and thereby selectively promote their business services to said website's visitors and users within their local business service areas. Existing decedent memorializing websites have attempted to recruit and affiliate with funeral service directors and their funeral home businesses. Since most such businesses are local in scope and existing decedent memorial websites do not have dedicated local community homepages and or related pages there has been limited interest in such affiliation by local funeral service directors.

Other unique advantages of the structure, function, and organization of said website are also recognizable. Because of said website's local focus and its potential for documenting the historical heritage of a local community through memorializing its deceased citizens; special categories of historically expert and oriented local users and or historically significant memorials can be established by said website. For instance, the head of a local historical society or a town official could register on said website as an affiliated local historian or town official for the purposes of documenting the heritage of a particular community by creating and or earmarking online memorials for that community's historical figures, community heroes, distinguished citizens, and or favorite sons and daughters on said website's specified local and community pages. As such the dedicated community web pages of said website would become a historical asset for the specified community and could help build the reputation and work of the local historian involved. The unique community-based structure of said website and its community-based organization of memorials will also allow for the creation of non-geographic communities to which a decedent's memorials could be assigned, thereby providing a web-based asset to help said communities preserve their historical heritage and continuity. Examples might include communities associated with churches, social and fraternal organizations, veterans groups, and a host of other types of citizen-based communities that exist within localized geographic communities as well as across multiple geographic communities within the larger geographic service area of said website.

### SUMMARY

A software based website machine that permits its website's user to create and display online memorials on said website to remember and honor decedents in such a way that said memorials are organized by and displayed according to and referenced to said website user's selection of a hometown community or local community or otherwise specified community or communities from a plurality of possible hometown, local, or otherwise specified communities within the service area of said website.

### DRAWINGS AND REFERENCE NUMERALS

Drawings labeled 1/11-11/11 are submitted.

Drawing Sheet 1/11—Home Web Page
a) 1—User Registration Link
b) 2—Communities Page Link
c) 3—Local Historians Link
d) 4—Memorial Creation Link
e) 5—Browse Memorials By Community Link
f) 6—Funeral Directors Information Link
g) 7—Hometown Memorials Search Links
h) 8—Name Based Memorial Search Link

2) Drawing Sheet 2/11—User Registration Interface Web Page

3) Drawing Sheet 3/11—New Memorial Creation Interface Web Page

4) Drawing Sheet 4/11—Communities Web Page

5) Drawing Sheet 5/11—Individual Community Home Web Page
a) 9—Individual Funeral Home Advertisement and Link
b) 10—Individual Funeral Home Advertisement and Link

6) Drawing Sheet 6/11—Decedent Memorial Web Page

7) Drawing Sheet 7/11—Funeral Director's General Information Web Page

8) Drawing Sheet 8/11—Funeral Directors Registration Web Page

9) Drawing Sheet 9/11—Individual Funeral Home and Director's Home Web Page

10) Drawing Sheet 10/11—Local Historians Registration Information Web Page

11) Drawing Sheet 11/11—Community-Based Historical Figure's Web Page

### DETAILED DESCRIPTION—PREFERRED EMBODIMENT

The invention is a regional, national, or international trans-community website specifically designed to allow said website's users to create, publish, display, and maintain online memorials for deceased family members, friends, loved ones, and or others on the pages of said website that are dedicated to each local and or geographically or otherwise identifiable community, hometown, or local community within said website's larger regional, national, or international business service area. Said website will organize, display, and reference memorials placed on it by users to local geographically identifiable communities and or other identifiable communities as specified by such users. To achieve this, said website will create and maintain a unique local community home page or set of unique community specific web pages for each and every memorial it publishes for its users. This will allow said website's users and visitors to specifically search for, locate, and view memorials that can be accessed through or have been placed on a specific community's home page or its related community web pages on said website. Such will also have the effect of allowing said website's users to visit or publish online memorials for family, friends, loved ones, and others specifically as a part of the historical heritage of each community that is identified and maintained as such on said website. The existence of such dedicated local and other community web pages on said website will then create a mutually beneficial possible business relationship between funeral service directors who register as locally affiliated funeral service directors on said website and said website and its operating company, such that said website's registered local funeral service directors will be able to selectively promote their business services on the web pages of said website which are dedicated to their local business service areas.

Operation of Invention

The website invention herein described will be accessible to users and visitors through common search engines and or through its designated URL or URLs on the World Wide Web. Said website's programming will create and display a home page and other web pages that will display and provide links that will allow:
1) said website's visitors to register as website users by activating a link. See 1 on drawing sheet 1/11, which transitions the visitor to the user registration interface shown in drawing sheet 2/11.
2) said website's visitors and users to access decedents' memorials, an example of which is shown in sheet 6/11, according to the hometown and or local community or other community or communities selected for the listing and display of said memorials through activating said website's links. See links 2, 5, 7, and 8 shown on drawing sheet 1/11.
   a) Links at 2 and 5 transition the website's visitor or user to the “Communities” page shown in drawing sheet 4/11, which allows said website's visitors and users to search for memorials by community.
   b) Search links at 7 transition said website's visitor or user to the hometown home page that matches the entered search parameter.
   c) Search link at 8 allows said website's visitor or user to search for memorials by decedent's name.
3) said website's users to create memorials for deceased friends, loved ones, family members, and or others according to the user's choice of community or communities by activating a link. See 4 on drawing sheet 1/11, which transitions the user to said website's memorial creation interface shown on drawing sheet 3/11.
4) funeral directors to register in their communities and local business service areas and to affiliate with said website and its operating company by activating links. See 6 on drawing sheet 1/11, which sequences to said website's general information page for funeral directors shown in drawing sheet 7/11 which in turn contains a link to the funeral director's registration interface shown in drawing sheet 8/11.
5) local historians to register in their local communities by activating a link. See 3 on drawing sheet 1/11. Registration as a local historian on said website empowers the registrant to help preserve their community's history and heritage by memorializing and identifying their community's historical figures, an example of which is shown is drawing sheet 11/11, on their community's dedicated web pages on said website. Decedent's memorials as posted by users will be accessible through the links shown above and through various combinations of links on said website's home page and or other pages. Said memorials will always be listed and displayed on or through at least one community's home page, an example of which is shown on drawing sheet 5/11, and or through its related community's web pages. Said memorials may also be listed and displayed through the community homepages and related web pages of other communities as identified and selected by the registered users who create said memorials. As shown in links at 9 and 10 on drawing sheet 5/11, local business service area listings and advertisements for registered and affiliated funeral homes and their funeral directors are provided on each community's home page within said website. Said listings and advertisements contain links to the registrant's business promotional web pages contained within said website, an example of which is shown is drawing sheet 9/11, and or to the registrant's free standing, independent, and separate proprietary business promotional website.

### CONCLUSIONS, RAMIFICATIONS, AND SCOPE

Accordingly the reader will note that the website invention herein described by organizing, listing, and displaying decedent's memorials according to community provides significant advantages and conveniences for website visitors and users which include providing a community context for decedent's memorials, creating a more convenient and relevant search experience for website visitors who wish to find decedent's memorials from their community or a given community which includes the alphabetical listing of and or browsing through memorials by community.

Said website's organization of decedent's memorials by community and its establishment of a community home page for each memorial created within it as well as for each registered funeral director's community of business also creates the potential for a mutually beneficial business relationship between the website's registered funeral directors and their funeral home businesses and said website and its operating company to include fee based listing, advertising, and promotion of said funeral service director's business and services within his or her local business service area that is covered by said website's community home page specific to that funeral director's location and local business service area.

Furthermore documenting and preserving a community's heritage and history through memorializing its deceased citizens in a more accessible, integrated, and unified manner than has previously been available on decedent memorial websites available through the World Wide Web provides communities and their citizens with an innovative and important historical resource and asset.

Although the description above contains specificities, these should not be construed as limiting the scope of the invention but as merely providing illustrations of some of the preferred embodiments of this invention. Thus the scope of this invention should be determined by the appended claims and their legal equivalents, rather than by the examples given.

1) A software-based website machine that permits its website's user to create and display online memorials on said website to remember and honor decedents in such a way that said memorials are organized by and displayed according to and referenced to said website user's selection of a hometown community or local community or other community or communities from a plurality of possible hometown communities or local communities or other communities in the service area of said website, comprising:
a) a software-based website user registration interface
b) a software-based website user's memorial creation and editing interface either within the hometown community or local community or other community's web pages on said website and or through a generalized memorial creation interface on said website which utilizes a software-based tool or tools for selecting a hometown community or local community or other community or communities as pertaining to and referenced to the memorial being created
c) a web page or web pages on said website on which said website's user created memorials are accessed and or displayed by said website's visitors and or users according to the hometown community or local community or other community or communities selected during the website user's memorial creation or editing process on said website.

2) A method for an internet website user to create, publish, organize, list, and display online memorials for decedents from a larger regional, national, or international community on a website according to the website user's choice of specified smaller hometown community, local community, or other community or communities within that larger regional, national, or international community, compromising the steps of:
a) registering the website user as a memorial creator through a website registration interface tool on said website
b) permitting the registered website user to create and or edit a memorial or memorials with relevant website interface tools on said website
c) allowing the registered website user to select the hometown community, local community, or other community or communities according to which his or her created memorial or memorials will be published, organized, listed, and displayed on said website
d) publishing, organizing, listing, and displaying said memorials on discrete community home pages and related web pages of said community on the website which are dedicated to those memorials specified as pertaining to the hometown community, local community, or other community or communities selected by the registered user.

3) A method of publishing, organizing, listing, and displaying online memorials for decedents from within a larger geographic community on an internet website that publishes, organizes, lists, and displays, said memorials on and through the use of discrete and dedicated local and other community home pages and related web pages which creates an advantaged business relationship opportunity between said website and its operating company and said website's registered and affiliated local community funeral service directors, comprising the following steps:
a) registering local funeral service directors through said website's registration interface tool as participating affiliates who can provide online memorial creation services for clients in their local business service areas through said website
b) listing, displaying, and promoting registered and affiliated local funeral service directors and their businesses on discrete and dedicated local community home pages and related web pages of said website that relate to the funeral service director's local business service area
c) creating a discrete promotional and informational web page for each registered funeral service director within said website
d) providing website visitors and users with discrete and dedicated local community home pages and related web pages on the website with a link or links to the independent websites of registered and locally affiliated funeral service directors and or to each registered funeral service director's discrete promotional web page or web pages within said website for the further promotion of the funeral service director's business in his or her local business service area.

4) A method of publishing, organizing, listing, and displaying online memorials for decedents from within a larger geographic community on an internet website that publishes, organizes, lists, and displays said memorials according to said website user's selected hometown community, local community or other community or communities through the use of discrete and dedicated local and other community home pages and related web pages which creates the potential for the existence of a unique internet-based historical reference and asset for said hometown community or local community or other community or communities on said website as a repository for information about and memorials to said community's significant and historic figures, compromising the following steps:
a) registering local historians through said website's registration interface tool as participating local historians who can create online memorials for said local and other communities' significant historic persons and figures
b) providing said website users and visitors with discrete and dedicated hometown community or local and or other community home pages and related web pages on the website with links to memorials created for and about said hometown community's or local and or other community's significant historical figures.
